(19) United States
(12) Patent Application Publication
(10) Pub. No.: US 2024/0014586 A1
(43) Pub. Date: Jan. 11, 2024

(54) CONNECTING-FINGER CONNECTOR, AND POWER CONNECTION MODULE AND POWER SUPPLY CABINET THEREOF

(71) Applicant: ZTE CORPORATION, Shenzhen (CN)

(72) Inventors: Qianbin CHEN, Shenzhen (CN); Yankun JIANG, Shenzhen (CN); Wenyu SU, Shenzhen (CN); Ruijian YANG, Shenzhen (CN); Anning ZHANG, Shenzhen (CN)

(21) Appl. No.: 18/253,719

(22) PCT Filed: Oct. 9, 2021
(86) PCT No.: PCT/CN2021/122883

§ 371 Date: May 19, 2023

(30) Foreign Application Priority Data
Nov. 19, 2020 (CN) 202011303798.9

(51) Int. Cl. H01R 12/72; H01R 13/11; H01R 13/24; H01R 13/512

(52) U.S. Cl. CPC H01R 12/722; H01R 13/11; H01R 13/2407; H01R 13/512

(57) ABSTRACT

Disclosed are a connecting-finger connector, a power connection module therefor, and a power supply cabinet. The connecting-finger connector may include a first contact module and a connecting member. The first contact module includes a first main body portion and a first contact portion configured to be electrically connected to a connecting finger, and the first contact portion is electrically connected to the first main body portion. The connecting member is provided with a mounting structure configured to connect an external terminal to the first main body portion.

### CROSS-REFERENCE TO RELATED APPLICATION

This application is a national stage filing under 35 U.S.C. § 371 of international application number PCT/CN2021/122883, filed Oct. 9, 2021, which claims priority to Chinese patent application No. 202011303798.9, filed Nov. 19, 2020. The contents of these applications are incorporated herein by reference in their entirety.

### TECHNICAL FIELD

The present disclosure relates to the field of slot modules, in particular to a connecting-finger connector, a power connection module therefor, and a power supply cabinet.

### BACKGROUND

For a communication energy device, a charging pile, etc., a rectifier portion is usually made into a pluggable module to facilitate maintenance. Currently, in the industry, the connecting-finger process is widely adopted to achieve the pluggable connection of the above-mentioned module. In particular, a connecting finger is disposed on a board of a rectifier module, and a connecting-finger connector is disposed in a cabinet on an opposite side to achieve the pluggable connection through the cooperation between the connecting finger and the connecting-finger connector.

A metal contact module of the connecting-finger connector corresponding to the above-mentioned module is usually thin. In order to connect the metal contact module of the connecting-finger connector to an external metal sheet, an additional element is required to lock the external metal sheet at the metal contact module. For example, the contact module of the connecting-finger connector is required to be connected and fixed to an external copper busbar or wiring terminal. At present, a common means is to rivet nuts on a special-shaped copper busbar or wiring terminal, and lock the copper busbar or wiring terminal to the contact module through the cooperation between screws and nuts. Obviously, such fixing means is not compatible with standard connecting members, and the adoption of the above-mentioned non-standard connecting members requires additional procurement or manufacturing, which undoubtedly increases the material cost and later maintenance cost of the device.

### SUMMARY

The following is an overview of the subject described in detail herein. This overview is not intended to limit the scope of protection of the claims.

Embodiments of the present disclosure provide a connecting-finger connector, a power connection module therefor, and a power supply cabinet, which eliminate the need to connect a connecting member of a connecting-finger connector by a non-standard external terminal, thereby saving the material cost of the device and facilitating subsequent maintenance of the device.

In accordance with a first aspect of the present disclosure, an embodiment provides a connecting-finger connector, including:
a first contact module, including a first main body portion and a first contact portion configured to be electrically connected to a connecting finger, the first contact portion being electrically connected to the first main body portion; and
a connecting member, provided with a mounting structure configured to connect an external terminal to the first main body portion.

In accordance with a second aspect of the present disclosure, an embodiment provides a power connection module, including the connecting-finger connector mentioned above in the first aspect.

In accordance with a third aspect of the present disclosure, an embodiment provides a power supply cabinet, including the power connection module mentioned above in the second aspect.

Other features and advantages of the present disclosure will be set forth in the following description, and partly become obvious from the description, or understood by implementing the present disclosure. The objects and other advantages of the present disclosure can be realized and obtained by the structure particularly pointed out in the description, claims, and accompanying drawings.

### BRIEF DESCRIPTION OF DRAWINGS

The drawings are used to provide a further understanding of the technical schemes of the present disclosure and constitute a part of the description, and the drawings and the examples of the present disclosure are used to illustrate the technical schemes of the present disclosure and do not constitute a limitation to the technical schemes of the present disclosure.

FIG. 1 is a cross-sectional view of a connecting-finger connector provided in Example one of the present disclosure;

FIG. 2 is a cross-sectional view of another structure of a connecting-finger connector provided in Example one of the present disclosure;

FIG. 3 is a cross-sectional view of another structure of a connecting-finger connector provided in Example one of the present disclosure;

FIG. 4 is a cross-sectional view of a connecting-finger connector provided in Example two of the present disclosure;

FIG. 5 is a schematic view showing bus connection of three main body portions provided in Example two of the present disclosure; and

FIG. 6 is a perspective view of a power connection module provided by an embodiment of the present disclosure.

### DETAILED DESCRIPTION

To make the objects, technical schemes and advantages of the present disclosure clearer, the present disclosure will be further described in detail in conjunction with the accompanying drawings and embodiments. It should be understood that the specific embodiments described here are only used to illustrate the present disclosure, and are not intended to limit the present disclosure.

Embodiments of the present disclosure provide a connecting-finger connector, a power connection module therefor, and a power supply cabinet. The connecting-finger connector is internally provided with a contact module and a connecting member which are connected with each other, and the connecting member is internally provided with a mounting structure configured to connect an external terminal to the contact module, such that the external terminal can be directly mounted and fixed to the contact module without adopting a non-standard external terminal to connect to the contact module, thereby saving the procurement cost of non-standard structural members and later maintenance cost brought by adopting the non-standard structural members.

The embodiments of the present disclosure will be further illustrated in conjunction with the drawings.

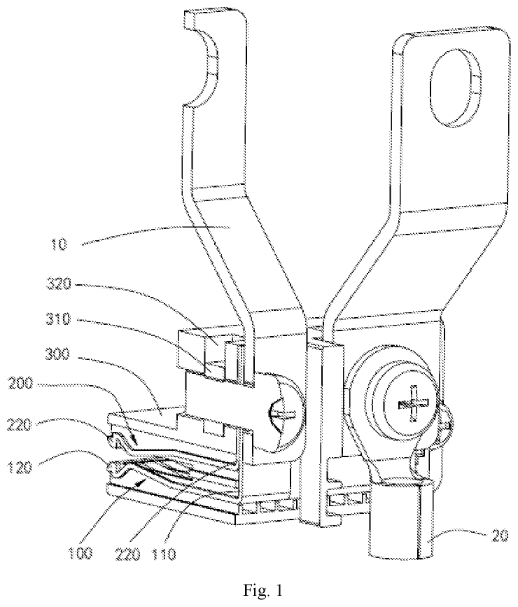

Referring to FIG. 1, an embodiment of the present disclosure provides a connecting-finger connector, including a first contact module 100 and a connecting member 300.

The first contact module 100 includes a first main body portion 110 and a first contact portion 120 configured to be electrically connected to a connecting finger, and the first contact portion 120 is electrically connected to the first main body portion 110.

The connecting member 300 is provided with a mounting structure configured to connect an external terminal to the first main body portion 110.

In this embodiment, the first contact module 100, as a portion of the connecting-finger connector coming into contact with the connecting finger, includes a first contact portion 120 and a first main body portion 110. The first contact portion 120 is usually connected to the connecting finger in the form of a metal contact sheet, and a board where the connecting finger is located is inserted into a slot of the connecting-finger connector to enable contact of the connecting finger with the metal contact sheet in the connecting-finger connector, so as to realize signal transmission or power transmission. The connecting-finger connector, as an intermediary connecting device, connects a control terminal with the board where the connecting finger is located or connects a power supply terminal with the board where the connecting finger is located. However, the existing connecting-finger connector has some structural limitations, making it difficult for the external terminal to be fixed to the connecting-finger connector. For example, the metal contact sheet is configured for power transmission, and because the metal contact sheet is thin, a connecting portion of the external terminal is usually thin (such as a terminal on a copper busbar or an annular metal terminal at the head of a wire). Therefore, in order to clamp the metal contact sheet and the external terminal together, it is often necessary to reform the external terminal by, for example, riveting nuts on a special-shaped copper busbar, and locking the metal contact sheet and the external terminal through the cooperation between screws and nuts. For another example, the metal contact sheet is configured for signal transmission and is connected with a signal transmission board, and it is also difficult to lock contacts or pins on the signal transmission board to a signal line, which requires modifying a terminal or wiring on the signal line. Under the above circumstance, non-standard external terminals need to be redesigned and purchased additionally, which is not universally applicable, resulting in an increase in material and design costs of the product. Moreover, in the later maintenance process, in case of replacing an external terminal, only a non-standard external terminal can be selected, resulting in an increase of maintenance costs for maintenance personnel. In order to solve the problem of high cost caused by the adoption of the non-standard external terminal, in the embodiment of the present disclosure, the connecting member of the connecting-finger connector is provided with a mounting structure which connects the external terminal to the first main body portion 110. By disposing the mounting structure in the connecting-finger connector, an external terminal of a standard member can be directly fixed to the mounting structure to achieve connection to the first contact module 100 without adopting a non-standard external terminal, thereby saving design or procurement costs of non-standard external terminals, and facilitating replacement and maintenance of maintenance personnel in the later stage.

Two examples are given below to illustrate the schemes of the present disclosure.

### Example One

In this example, the first contact module 100 is a power contact member, configured to transmit external power to a power pin on a connecting finger. In this case, the first contact portion 120 and the first main body portion 110 of the first contact module 100 are both metal contact sheets. Referring to FIG. 1, the first contact portion 120 is configured to be electrically connected to a connecting finger, and the first main body portion 110 is configured to be connected to an external terminal. In order to adapt to an external terminal of a standard member, the connecting-finger connector in this example is provided with a connecting member 300. The connecting member 300 is provided with a mounting structure located on one side of the first main body portion 110, and the external terminal is located on the other side of the first main body portion 110. Thus, installation and maintenance personnel can lock the first main body portion 110 and the external terminal to the mounting structure by adopting a fastening method adaptable to the mounting structure, thereby enabling the external terminal to be electrically connected to the first main body portion 110 to achieve power transmission.

It can be understood that the above-mentioned mounting structure may be implemented in different ways. For example, referring to FIG. 1, the mounting structure is a connecting hole provided with internal threads. The first main body portion 110 is located outside the connecting hole and is provided with a first via hole which is communicated with the connecting hole. Since the external terminal is configured for power transmission, the external terminal of the standard member is usually a copper busbar 10 or a wire with an annular metal terminal at one end. The copper busbar 10 is provided with a circular hole or a notch, and the annular metal terminal is also provided with an internal circular hole. In this way, a screw 30 is used to successively pass through the external terminal and the first via hole to form a threaded fit with the internal threads of the connecting hole. The head of the screw 30 is then utilized to press the external terminal onto the first main body portion 110 to achieve an electrical connection between the external terminal and the first main body portion 110.

The connecting member 300 may be a housing of the connecting-finger connector or a structure fixed in other positions. Taking the housing as an example, the first contact module 100 is accommodated in the housing, and the connecting hole is formed to facilitate the connection of the first main body portion 110 on the first contact module 100 with the external terminal. The connecting hole may be formed in various ways, for example, internal threads are obtained by directly processing and molding, internal threads are tapped after machining a via hole or a blind hole in the housing, or internal threads are formed by embedding a nut. In this case, the connecting member 300 is provided with an embedded nut 310 and a nut fixing slot 320, and a mounting structure is formed on the embedded nut 310. The embedded nut 310 is disposed in the nut fixing slot 320, and a slot wall of the nut fixing slot 320 is provided with a through hole which enables the connecting hole to be communicated with the first via hole. In this way, the screw 30 passes through the external terminal, the first via hole and the through hole in sequence to form a threaded fit with the embedded nut 310. Since the embedded nut 310 is fixed in the nut fixing slot 320, the head of the screw 30 can tightly press the external terminal and the first main body portion 110. By internally disposing the mounting structure, the external terminal of the standard member can be directly fixed to the connecting-finger connector without adopting a non-standard member.

The connecting-finger connector in this example may be applied to the field of modular rectifier power supplies. A modular rectifier power supply is usually pluggable. To be specific, a connecting finger is led out from one side of the modular rectifier power supply, a connecting-finger connector is set in a mounting cabinet or mounting frame, and the modular rectifier power supply is inserted into the connecting-finger connector to realize rack mounting of the modular rectifier power supply, which is suitable for a power supply cabinet for communication, a power supply device for a charging pile, etc. Taking the power supply cabinet for communication as an example, a plurality of connecting-finger connectors disposed side by side, even several rows of such connecting-finger connectors disposed side by side, are integrated in the power supply cabinet, and a module mounting mode of the power supply cabinet is usually from front to back. Thus, the modular rectifier power supply is also mounted in such a way that it is inserted in a direction from a front panel to a back panel of the power supply cabinet, so that the connecting finger of the modular rectifier power supply is inserted into the connecting-finger connector, and then the connecting-finger connector is powered on the back panel by installation and maintenance personnel.

Due to the fact that a heat dissipation vent of the modular rectifier power supply is usually provided at the rear (back), in order to prevent the board where the connecting-finger connector is located from blocking the heat dissipation vent of the modular rectifier power supply, the board where the connecting-finger connector is located is often set parallel to a length direction of the modular rectifier power supply. In this way, the board where the connecting-finger connector is located will not block the rear heat dissipation vent of the modular rectifier power supply. However, this brings a problem of inconvenient mounting, because a metal contact sheet in the connecting-finger connector is also set parallel to the length direction of the modular rectifier power supply. In order to fix the external terminal and the metal contact sheet, the screw 30 is required to be driven in a direction perpendicular to the length direction of the modular rectifier power supply, but the driving operation is usually blocked by organic frames or other modules in a vertical direction, which makes it difficult to mount the screw 30 and inconvenient for subsequent maintenance. In order to facilitate the fixing of the external terminal and the metal contact sheet, an angle is formed between the first main body portion 110 and the first contact portion 120 in this example. Since the first main body portion 110 is electrically connected to the connecting finger, the first main body portion 110 is generally parallel to the length direction of the modular rectifier power supply, while the first contact portion 120 is tilted, to facilitate the mounting of the external terminal. It can be understood that the angle between the first main body portion 110 and the first contact portion 120 can be set as needed. For example, the first main body portion 110 and the first contact portion 120 are perpendicular to each other. In terms of technology, an integrally formed first contact module 100 may be adopted, and may be bent by 90 degrees to form the first main body portion 110 and the first contact portion 120. In this way, referring to FIG. 1, it is possible to drive the screw 30 from back to front, without the problem of blocking when driving the screw 30. Moreover, due to a small size of the first main body portion 110, the heat dissipation vent of the modular rectifier power supply will not be blocked.

In order to stably connect the connecting finger, in this example, a second contact module 200 may be further included, which is substantially the same as the first contact module 100 in structure. Referring to FIG. 1, the second contact module 200 includes a second main body portion 210 and a second contact portion 220 configured to be electrically connected to a connecting finger. The second main body portion 210 and the second contact portion 220 are connected by a bend, the first contact portion 120 and the second contact portion 220 form a slot for holding the connecting finger, and the first main body portion 110 and the second main body portion 210 are electrically connected. The first contact portion 120 and the second contact portion 220 may be in the form of elastic sheets, and elastic sheets on both sides are disposed oppositely to reduce the distance between the first contact portion 120 and the second contact portion 220. The connecting finger is inserted in the slot formed by the first contact portion 120 and the second contact portion 220 and is clamped and fixed by the elastic sheets on both sides.

The second main body portion 210 is provided with a second via hole which is communicated with the first via hole. The screw 30 can lock the external terminal, the first main body portion 110 and the second main body portion 210 together to the mounting structure. It can be understood that as long as there is an electrical connection between the first main body portion 110 and the second main body portion 210, the first main body portion 110 and the second main body portion 210 may be structurally connected in many ways. For example, only a part of the first main body portion 110 is in contact with the second main body portion 210, and the first via hole may be or may not be formed at the contact part. For another example, the first main body portion 110 and the second main body portion 210 are parallel plate-shaped structures. Referring to FIG. 1, the first main body portion 110 and the second main body portion 210 overlap.

In this example, the first contact module 100 may further include an abutting portion 130, and the connecting member 300 may include a limiting portion 330. The abutting portion 130 abuts against the limiting portion 330 to limit a displacement of the first contact module 100 in an insertion direction of inserting the connecting finger into the connecting-finger connector. Similarly, taking the rack mounting of the modular rectifier power supply as an example, the connecting finger is inserted into the connecting-finger connector from front to back, and the first contact module 100 of the connecting-finger connector may retreat due to friction. In this example, the first contact module 100 can be prevented from retreating through the cooperation between the abutting portion 130 and the limiting portion 330, thus enhancing the stability of the first contact module 100 and increasing the pluggable times of the connecting-finger connector.

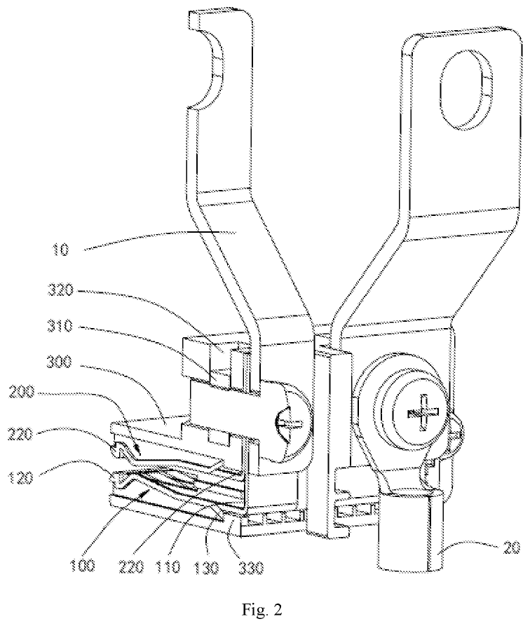

The abutting portion 130 and the limiting portion 330 may cooperate in many ways. Taking the structure shown in FIG. 2 as an example, the abutting portion 130 is a barb strip tilted along the surface of the first contact portion 120, and the limiting portion 330 is a protruding step on the connecting member 300. A drop surface of the protruding step faces the connecting-finger side, and the abutting portion 130 abuts against the drop surface of the limiting portion 330, thus limiting the retreat of the first contact module 100. In addition, the abutting portion 130 may also be a step protruding along the surface of the first contact portion 120, and the step of the abutting portion 130 can cooperate with the step of the limiting portion 330 to achieve the effect of limiting the retreat of the first contact module 100.

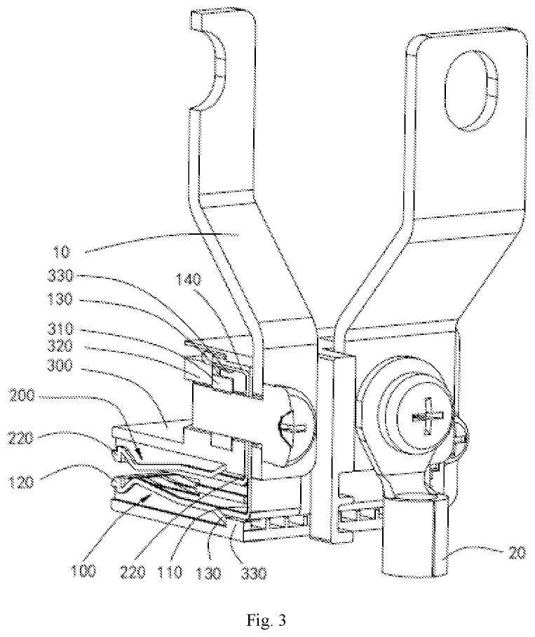

In order to further fix the position of the first contact module 100 and prevent the first contact module 100 from being damaged by the strong insertion of the connecting finger into the connecting-finger connector, the first contact module 100 further includes a first additional portion 140. Referring to FIG. 3, the first additional portion 140 is connected to the first main body portion 110 and is parallel to the first contact portion 120, such the first contact module 100 is overall C-shaped. The first additional portion 140 is also provided with an abutting portion 130. Near the first additional portion 140, the connecting member 300 is also provided with a limiting portion 330. Therefore, the first additional portion 140 can also provide resistance to prevent the first contact module 100 from retreating. It can be understood that the second contact module 200 may also be provided with an abutting portion 130 similar to the structure of the first contact module 100. As long as the connecting member 300 is also provided with a limiting portion 330 at a corresponding position of the abutting portion 130 of the second contact module 200, the second contact module 200 can be prevented from retreating when the connecting finger is inserted into the connecting-finger connector. Therefore, it can be understood that the first contact module 100 or the second contact module 200 may be provided with a plurality of abutting portions 130, and the connecting member 300 may be provided with limiting portions 330 corresponding to the abutting portions 130. The number and shape of the abutting portions 130 and the limiting portions 330 may be set according to the actual usage scenarios, which will not be limited herein.

Through the mounting structure in this example, the external terminal of the standard member can be conveniently fixed to the connecting-finger connector without adopting an external terminal of a non-standard member to cooperate with the metal contact sheet of the connecting-finger connector. On the one hand, in this example, the use of non-standard members is eliminated and the costs of designing and using non-standard members are reduced. On the other hand, during later maintenance, it is convenient for maintenance personnel to disassemble and replace external terminals of standard members, reducing maintenance costs.

### Example Two

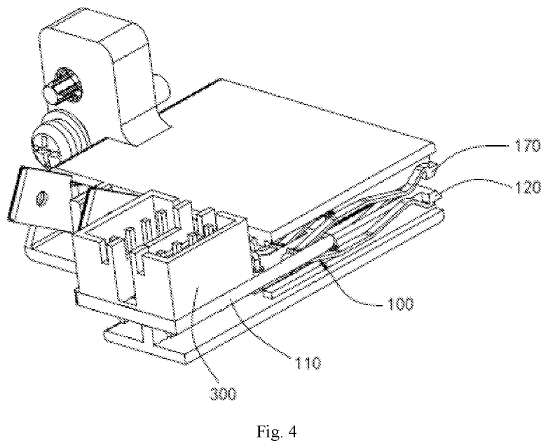

In this example, the first contact module 100 is a signal contact member configured to transmit external electrical signals to signal pins on the connecting finger. In this case, the first contact portion 120 of the first contact module 100 is a metal contact sheet, and the first main body portion 110 is a printed circuit board. Referring to FIG. 4, the first contact portion 120 includes a first signal contact region configured to be electrically connected to a connecting finger, and a second signal contact region configured to be electrically connected to the first main body portion 110. The first contact module 100 is integrally fixed to the housing of the connecting-finger connector, and the first contact portion 120 is in a strip shape, with one end serving as the first signal contact region for contacting the connecting finger and the other end as the second signal contact region for connecting contacts on the first main body 110. The connecting member 300 is a connector electrically connected to the first main body portion 110. The mounting structure is a socket formed in the connecting member 300. The first main body portion 110 is provided with several conductive holes 160 which are holes reserved in the printed circuit board configured to connect the external terminals. By combining the connecting member 300 with the external terminal, and then inserting the combined connecting member 300 and external terminal into the conductive hole 160 of the printed circuit board as a whole, the connection between the external terminal and the conductive hole 160 is achieved, thereby realizing signal transmission between the external terminal and the signal contact member.

Similarly, taking the modular rectifier power supply as an example, in addition to the power pins, the connecting finger of the modular rectifier power supply further includes signal pins, configured to transmit a variety of weak current signals, such as phase detection signals, slot recognition signals, bus communication signals, etc. In a traditional connecting-finger connector, the printed circuit board and the external terminal have no structures allowing for matching and mounting with each other structurally, so it is often required to connect the contacts of the printed circuit board with the external terminal by means of welding, bonding or the like, which leads to the problems of troublesome mounting and post-maintenance difficulties. In this example, through the socket in the connector, the installation and maintenance personnel can conveniently connect the external terminal to the conductive hole 160 of the printed circuit board.

Because the mounting cabinet or mounting frame is usually provided with a plurality of connecting-finger connectors, only when which slot corresponding to which connecting-finger connector is recognized by a controller of the cabinet, can the controller accurately exchange information. In order to achieve slot recognition on the first main body portion 110, the first main body portion 110 is provided with a voltage dividing element 150 configured to provide a voltage value for determining whether the first signal contact region is electrically connected to the connecting finger. It can be understood that the voltage dividing element 150 may be connected to two voltage pins on the first main body portion 110, thereby forming a potential difference on the voltage dividing element 150. Since the first main body portion 110 of each connecting-finger connector is provided with a voltage dividing element 150, the controller can achieve slot recognition based on the magnitude of the voltage by collecting a voltage drop of the voltage dividing element 150 of each connecting-finger connector. The specific slot recognition method may be set based on the connection relationship between the first main body portions 110 of the connecting-finger connectors, such as a series voltage dividing relationship formed among all voltage dividing resistors, which is not limited herein.

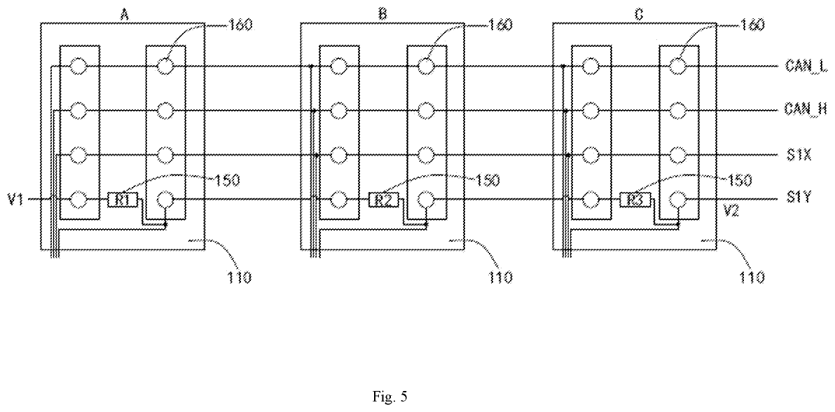

On the other hand, a bus structure may also be formed among all the first main body portions 110. Referring to FIG. 5, taking three first main body portions 110 located in a same mounting frame as an example, the three first main body portions 110 have identical circuit structures, and are all provided with eight conductive holes 160 distributed on a first side and a second side, with each side being provided with four conductive holes 160. The conductive holes 160 on the first side are all configured to connect the external terminals, and the conductive holes 160 on the second side are connected to the conductive holes on the first side of a next first main body portion 110 through wiring. The three first main body portions 110 form a Controller Area Network (CAN) bus structure through the connection relationship shown in FIG. 5. It can be understood that different bus structures also have different connection modes, and the form of the bus structures is not limited here. The voltage dividing element 150 may also be connected to the CAN bus structure. For example, a conductive hole of each of a first and a last main body portions 110 of a CAN bus is selected to connect two different weak current voltages. All the voltage dividing elements 150 in the CAN bus are connected in series through the CAN bus structure, and the voltages of the voltage dividing elements 150 are sampled to achieve slot detection.

It can be understood that the first contact module 100 further includes a third contact portion 170 which includes a third signal contact region and a fourth signal contact region. The first signal contact region and the third signal contact region form a slot for holding the connecting finger, and the second signal contact region and the fourth signal contact region form a slot for holding the first main body portion 110. The above structure achieves stable holding of the connecting finger and of the first main body portion 110. Two slots are formed between the first contact portion 120 and the third contact portion 170, one for holding the connecting finger, and the other for holding the first main body portion 110, thereby enabling a stable connection between the first main body portion 110, the first contact module 100, and the connecting finger.

In this example, the external terminal is connected to the conductive hole 160 of the first main body portion 110 through an socket, which is simple and fast in mounting. Meanwhile, in the later maintenance process, the external terminal can be disconnected from the first main body portion 110 by directly disassembling the connector 300, facilitating the maintenance and replacement.

It is worth noting that the above examples one and two may be combined in a single connecting-finger connector. In this case, the connecting-finger connector can be connected to a connecting finger to realize power transmission and signal transmission. For example, the modular rectifier power supply is provided with power pins and signal pins, and a contact module corresponding to power transmission and a contact module corresponding to signal transmission are provided on the connecting-finger connectors at positions corresponding to the power pins and signal pins, to achieve the rectification process and power distribution control.

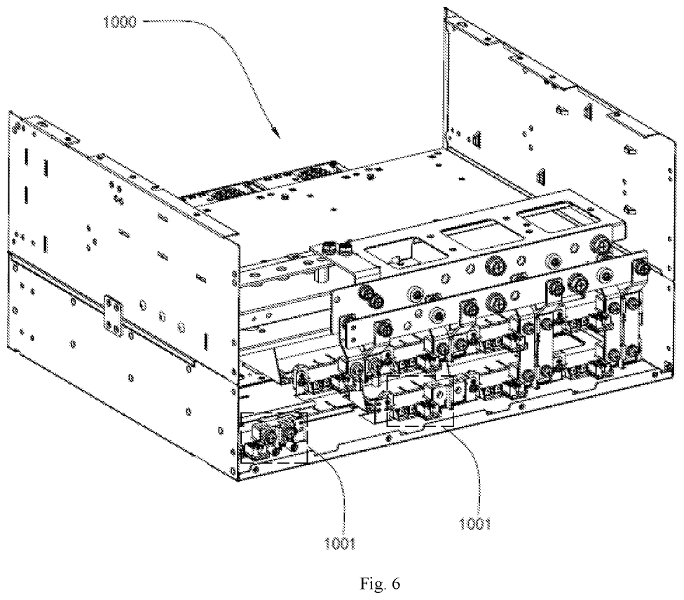

An embodiment of the present disclosure further provides a power connection module 1000, including the connecting-finger connector in the above example. The power connection module 1000 of this embodiment may be a rack mounted in a cabinet. Several connecting-finger connectors in the above example are integrated on the rack. For example, as shown in FIG. 6, seven connecting-finger connectors are provided in the power connection module 1000 and are distributed in two rows, with three in an upper row and four in a lower row, such that seven modular rectifier power supplies may be connected to realize high integration. By applying the connecting-finger connectors in the above example, the power connection module 1000 can facilitate the installation and maintenance personnel to connect the external terminal to the connecting-finger connector, and also facilitate the installation and maintenance personnel to disassemble and replace the external terminal during maintenance, thus overcoming the structural requirements of the ordinary connecting-finger connector for the external terminal. That is, it is not necessary to adopt non-standard external terminals, thereby saving the design and procurement costs of adopting non-standard members, and also saving later maintenance cost.

An embodiment of the present disclosure further provides a power supply cabinet, including the power connection module 1000. By integrating the power connection module 1000 in the power supply cabinet, the connecting-finger connector in the above example can be adopted to be connected with the external terminal. Because the connecting-finger connector has its own mounting structure, it is not necessary to adopt non-standard external terminals, saving the design and procurement costs of adopting non-standard members, and also saving later maintenance cost.

The above is a detailed description of the preferred implementations of the present disclosure, and the present disclosure is not limited thereto. Those having ordinary skills in the art can also make various equivalent modifications or substitutions without departing from the protection scope of the present disclosure, and these equivalent modifications or substitutions are included in the protection scope defined by the claims of the present disclosure.

1. A connecting-finger connector, comprising:
a first contact module, comprising a first main body portion and a first contact portion configured to be electrically connected to a connecting finger, the first contact portion being electrically connected to the first main body portion; and
a connecting member, provided with a mounting structure configured to connect an external terminal to the first main body portion.

2. The connecting-finger connector of claim 1, wherein the first contact module is integrally formed, and
the first main body portion and the first contact portion are connected by a bend.

3. The connecting-finger connector of claim 1, wherein the first main body portion is arranged on an outer side of the connecting member and is provided with a first via hole,
the mounting structure is a connecting hole provided with internal threads, and
the first via hole is communicated with the connecting hole.

4. The connecting-finger connector of claim 3, wherein the connecting member is provided with an embedded nut and a nut fixing slot,
the embedded nut is formed with the mounting structure and is arranged in the nut fixing slot, and
in a slot wall of the nut fixing slot, the nut fixing slot is provided with a through hole which enables the connecting hole to be communicated with the first via hole.

5. The connecting-finger connector of claim 2, further comprising a second contact module,
wherein the second contact module comprises a second body portion and a second contact portion configured to be electrically connected to the connecting finger,
the second body portion and the second contact portion are connected by a bend,
the first contact portion and the second contact portion form a slot for holding the connecting finger, and
the first main body portion is electrically connected to the second body portion.

6. The connecting-finger connector of claim 1, wherein the first contact module comprises an abutting portion,
the connecting member comprises a limiting portion, and
the abutting portion abuts against the limiting portion to limit a displacement of the first contact module in an insertion direction of inserting the connecting finger into the connecting-finger connector.

7. The connecting-finger connector of claim 1, wherein the first main body portion is a printed circuit board, and
the first contact portion comprises a first signal contact region configured to be electrically connected to the connecting finger and a second signal contact region configured to be electrically connected to the first main body portion,
the connecting member is a connector electrically connected to the first main body portion, and
the mounting structure is a socket arranged in the connecting member.

8. The connecting-finger connector of claim 7, wherein the first main body portion is provided with a voltage dividing element configured to provide a voltage value for determining whether the first signal contact region is electrically connected to the connecting finger.

9. The connecting-finger connector of claim 8, wherein the first main body portion is further provided with a signal connection terminal configured for cascade connection.

10. The connecting-finger connector of claim 7, wherein the first contact module further comprises a third contact portion,
the third contact portion comprises a third signal contact region and a fourth signal contact region,
the first signal contact region and the third signal contact region form a slot for holding the connecting finger, and
the second signal contact region and the fourth signal contact region form a slot for holding the first main body portion.

11. A power connection module, comprising a connecting-finger connector, wherein the connecting-finger connector comprises:
a first contact module, comprising a first main body portion and a first contact portion configured to be electrically connected to a connecting finger, the first contact portion being electrically connected to the first main body portion; and
a connecting member, provided with a mounting structure configured to connect an external terminal to the first main body portion.

12. A power supply cabinet, comprising a power connection module, wherein the power connection module comprises a connecting-finger connector comprising:
a first contact module, comprising a first main body portion and a first contact portion configured to be electrically connected to a connecting finger, the first contact portion being electrically connected to the first main body portion; and
a connecting member, provided with a mounting structure configured to connect an external terminal to the first main body portion.

13. The connecting-finger connector of claim 3, further comprising a second contact module, wherein the second contact module comprises a second body portion and a second contact portion configured to be electrically connected to the connecting finger,
the second body portion and the second contact portion are connected by a bend,
the first contact portion and the second contact portion form a slot for holding the connecting finger, and
the first main body portion is electrically connected to the second body portion.

14. The connecting-finger connector of claim 4, further comprising a second contact module, wherein the second contact module comprises a second body portion and a second contact portion configured to be electrically connected to the connecting finger,
the second body portion and the second contact portion are connected by a bend, the first contact portion and
the second contact portion form a slot for holding the connecting finger, and the first main body portion is electrically connected to the second body portion.

15. The connecting-finger connector of claim 8, wherein the first contact module further comprises a third contact portion,
the third contact portion comprises a third signal contact region and a fourth signal contact region,
the first signal contact region and the third signal contact region form a slot for holding the connecting finger, and
the second signal contact region and the fourth signal contact region form a slot for holding the first main body portion.

16. The connecting-finger connector of claim 9, wherein the first contact module further comprises a third contact portion,
the third contact portion comprises a third signal contact region and a fourth signal contact region,
the first signal contact region and the third signal contact region form a slot for holding the connecting finger, and
the second signal contact region and the fourth signal contact region form a slot for holding the first main body portion.
